(19) United States
(12) Patent Application Publication
(10) Pub. No.: US 2023/0062545 A1
(43) Pub. Date: Mar. 2, 2023

(54) Process the Generation of Gaseous Fuels

(71) Applicant: Origen Power Ltd, West Midlands (GB)

(72) Inventor: Tim Kruger, West Midlands (GB)

(21) Appl. No.: 17/799,313

(22) PCT Filed: Feb. 11, 2021
(86) PCT No.: PCT/GB2021/050314

§ 371 Date: Aug. 12, 2022

(30) Foreign Application Priority Data
Feb. 13, 2020 (GB) 2001960.0

(51) Int. Cl. C10J 3/72; C10K 3/04; C01B 3/50; C10J 3/16

(52) U.S. Cl. CPC C10J 3/725; C10K 3/04; C01B 3/50; C10J 3/16; C10J 2300/0956; C10J 2300/0973; C10J 2300/0996; C10J 2300/1659; C10J 2300/1884; C10J 2300/0913; C10J 2300/165; C10J 2300/1653

(57) ABSTRACT

A process and system for the generation gaseous fuels, the process comprising gasifying a carbonaceous fuel with vitiated air in the presence of lime and water to provide calcium carbonate, a gaseous fuel and heat; the system comprising a reactor for the gasification of the carbonaceous fuel with vitiated air in the presence of lime and water, and a heat exchanger to extract heat from the gaseous fuel. Use in the generation of gaseous fuels, in energy distribution and in grid energy firming.

The invention relates to a process for the generation of gaseous fuels, comprising gasifying a carbonaceous fuel in the presence of lime. In particular, the invention relates to a process comprising gasifying in vitiated air to provide calcium carbonate, a gaseous fuel and heat. A gaseous fuel generation system and use of the process or system in energy distribution are also disclosed.

The production of hydrogen and syngas from solid carbonaceous fuels is well known. Often production is via gasification reactions, for instance, hydrogen production from biomass is often described by the reaction scheme below (with glucose representing the cellulosic materials in the biomass):

C₆H₁₂O₆+O₂+H₂O→CO+CO₂+H₂+other species

Whereby the gasification is achieved, without combustion, in vitiated air. The carbon monoxide then reacts with water to form carbon dioxide and more hydrogen via a water-gas shift reaction, as shown below:

CO+H₂O→CO₂+H₂(+small amount of heat)

Depending upon the substrate used and the level of oxygen, the resulting gas mixture may also contain a mixture of other hydrocarbons. Therefore, it is often advantageous to include a further step of reforming the hydrocarbons with a catalyst to yield a clean syngas mixture of hydrogen, carbon monoxide, and carbon dioxide. Often, the hydrogen is separated and purified for separate commercial use.

One disadvantage of such systems is the need to provide energy to drive the endothermic gasification reaction. Generally, this is achieved by diverting some of the solid carbonaceous fuel from the gasification reaction to a combustion reaction. A result of this is that a proportion of the biomass is lost to the gasification process, reducing output per unit volume of starting material.

A further disadvantage is that carbon dioxide is produced, both in the initial gasification process and in the water-gas shift reaction. The carbon dioxide is either released into the atmosphere, where it contributes to climate change, or it must be captured, which is a generally expensive process.

The emission of carbon dioxide can be prevented using amine or calcium sorbents to bond with the carbon dioxide. The sorbent can subsequently be regenerated by heating, so as to release a pure stream of carbon dioxide that can be pressurised, and subsequently transported (via a pipeline) to a site where it can be permanently geologically sequestered.

The regeneration process is energy intensive, and thus—in addition to the capital outlay needed to provide the sorbent apparatus—there is a parasitic load on the gasification process, which requires the diversion of more of the carbonaceous fuel to supply this energy. This further reduces the output per unit volume of the carbonaceous fuel.

There is therefore a need to remove this parasitic load (if possible), whilst still capturing the carbon dioxide released, to seek to provide an efficient (often carbon-neutral or carbon-negative) process for the generation of gaseous fuels.

The invention is intended to overcome or ameliorate at least some aspects of these problems.

Accordingly, in a first aspect of the invention there is provided a process for the generation of gaseous fuels, the process comprising gasifying a carbonaceous fuel with vitiated air in the presence of metal oxide and water to provide a metal carbonate, a gaseous fuel and heat. This process, in particular the presence of the metal oxide, often lime, provides for a system where carbon dioxide is not present in the gaseous fuel. This removes the need to purify the syngas or hydrogen produced, and removes concerns about post-process sequestering of the carbon dioxide by-product. Instead, the carbon dioxide is used to recarbonate the lime (or other metal oxide) into calcium (or other metal) carbonate, a solid which is easily removed from the system. As such, there is no need for the sorbents commonly present to remove carbon dioxide from syngas or hydrogen production systems where carbonaceous fuels are the starting material. Whilst not explicitly mentioned, other products may also be generated dependent upon, in particular, the nature of the carbonaceous fuel.

Furthermore, the removal of carbon dioxide from the reaction system results in improved reaction dynamics of the water-gas shift reaction, as the removal of carbon dioxide as a product of this reaction, promotes the forward reaction of carbon monoxide and water to carbon dioxide and hydrogen.

As used herein, the term “lime” is generally intended to refer to calcium oxide, although calcium hydroxide may also be used, calcium oxide as calcium oxide can capture more carbon dioxide than calcium hydroxide. Further, although the application is cast generally in terms of lime and the production of calcium carbonate, it may be the case that other metal oxides, for instance s-block metal oxides such as magnesium oxide, sodium oxide or potassium oxide may be used alone or in combination to produce magnesium, sodium, potassium carbonates or combinations thereof, or combinations with calcium carbonate. Often, where lime is not used, the metal oxide will be an s-block metal oxide, often a group II metal oxide, often magnesium oxide derived from dolomite. As dolomite is often a combination of calcium and magnesium carbonates, the metal oxide may therefore also be a combination of calcium oxide (“lime”) and magnesium oxide (MgO).

The process may be said to comprise the following steps:

a) gasification of the carbonaceous fuel to produce carbon monoxide and hydrogen;

b) reaction of carbon monoxide with water to produce carbon dioxide and hydrogen; and

c) recarbonation of lime by carbon dioxide to produce calcium carbonate.

Whilst not explicitly mentioned, other products may also be generated dependent upon, in particular, the nature of the carbonaceous fuel. If necessary, these can be removed using conventional methods, such as catalytic reforming.

Without the lime, it would be necessary to add an additional stage to the gaseous fuel production process, in order to remove the carbon dioxide from the gases produced. This would add capital cost to the production facility, and operating costs to the process because of the need to, for instance, regenerate sorbents between uses, and to physically store and transport the carbon dioxide to long term sequestration facilities (for instance underground burial).

If sufficient oxygen is available, when a carbonaceous fuel is combusted in the presence of lime, the carbon dioxide released during the reaction will immediately be captured, as the lime reacts with it to form calcium carbonate. If, however, there is a lack or absence of oxygen, such as when air is vitiated (as in the invention), then there will either be incomplete combustion (in the event of there being a lack of oxygen) or no combustion (if there is no oxygen). In such circumstances the amount of heat generated will be less, but instead there will be production of a syngas (as used herein, a mixture of carbon monoxide and hydrogen, as carbon dioxide has been captured) or hydrogen as the carbonaceous fuel gasifies. As such, by controlling the oxygen levels present under reaction conditions, combustion will be prevented, and instead gaseous fuel is generated.

The gaseous fuel generation process may be described by the following overall reaction:

CₐH_{b}O_{c}+aCaO+N₂+H₂O→N₂+CₓH_{y}+(a-x)CaCO₃

Which could be simplified to remove the nitrogen from the equation (although this would remain present in the vitiated air) to read:

CₐH_{b}O_{c}+aCaO+H₂O→CₓH_{y}+(a-x)CaCO₃

where a, b and c are the molar component of the carbonaceous fuel, x may vary from 0 to 8 and y may vary from 2 to 14.

An example of the generation of gaseous fuels is shown below, using glucose as representative of the carbonaceous fuel.

a) gasification of the carbonaceous fuel to produce carbon monoxide and hydrogen:

C₆H₁₂O₆→6CO+6H₂;

b) reaction of carbon monoxide with water to produce carbon dioxide and hydrogen:

6CO+6H₂O→6CO₂+6H₂; and

c) recarbonation of lime by carbon dioxide to produce calcium carbonate:

6CaO+6CO₂→6CaCO₃.

The relative mass flows of the carbonaceous fuel, lime and vitiated air may be controlled to ensure that only trace, if any, amounts of carbon dioxide escape the system with the flue gases. Therefore, the flue gas may comprise in the range 0-0.001, or in the range 1×10⁻⁵-1×10⁻⁴ volume % carbon dioxide.

Normal gaseous fuel production processes (for instance syngas or hydrogen production) require a proportion of the carbonaceous fuel to be combusted to provide sufficient heat to drive the endothermic gasification process. However, with the addition of the recarbonation step, the overall reaction is heat-generating, and so a proportion of the carbonaceous fuel does not need to be combusted to provide heat energy—all of the carbonaceous fuel can be gasified. This provides for a more efficient process than has been known, as all of the carbonaceous fuel can be converted to gaseous fuel, without loss of energy potential in driving the conversion reaction. It is desirable to generate gaseous fuels from carbonaceous fuels, as these are generally cleaner (in that there are fewer unwanted products mixed with the fuel), easier to purify when necessary, and higher in per unit energy. This is particularly the case where the carbonaceous fuel is a solid fuel such as coal or biomass (any organic matter that is used as a fuel).

In addition, the overall reaction (e.g. C₆H₁₂O₆+6H₂O+6CaO→6CaCO₃+12H₂) requires water on the left hand side, this appearing in the water-gas shift reaction. Thus it is not necessary to completely dry the carbonaceous fuel prior to use in the process. This removes a cost and energy-intensive step usually associated with hydrogen or syngas production, in particular where the carbonaceous starting material is biomass.

As noted above, the recarbonation step also results in the removal of carbon dioxide, preventing its emission. This, if combined with a process that produces a ‘zero-emission lime’ can result in net negative emissions—the overall removal of carbon dioxide from the atmosphere. Typically, the term ‘zero-emission lime’ relates to lime produced by a process in such a way that all (or a substantial proportion) of the carbon dioxide generated by the production of the lime from calcium carbonate (both from the calcination of the calcium carbonate and any emissions associated with the combustion of the fuel required to calcined the calcium carbonate) is not emitted to the atmosphere, but is instead permanently sequestered. Thus the claimed process has the potential to generate hydrogen or syngas in a way that also removes carbon dioxide from the atmosphere, potentially providing carbon-negative gaseous fuel generation.

As used herein, the term “fuel” may be used to describe any material which can be burned to generate power. The carbonaceous fuel for use in the heat generation process may be gaseous, liquid or solid; although often it will be solid for ease of handling. However, as this is not essential, the carbonaceous material for use in the heat generation process may be selected from coal, coke, lignite, syngas, biomass (any organic matter that is used as a fuel), biogas (any gaseous fuel derived from the fermentation of organic matter), one or more hydrocarbons (solid, liquid or gaseous at room temperature) or a combination thereof. Where the carbonaceous fuel is a solid, it may be selected from coal, coke, lignite, biomass, one or more solid hydrocarbons, or a combination thereof. Often the carbonaceous fuel will be from a renewable source, such as biomass (for instance algal or cellulosic), or biogas if gaseous.

Furthermore, where the carbonaceous fuel is biomass, the biomass production itself will have removed carbon dioxide from the air via the photosynthetic process. In such cases, a typical heat generation process from biomass, assuming it involves the combustion of the carbonaceous fuel in oxygen, is broadly ‘carbon-neutral’ with as much carbon dioxide released as was initially captured during photosynthesis. There remains, however, a small detrimental impact on the climate from biomass conversion, as there will be an associated carbon footprint relating to the production, harvesting and transport of the biomass. However, the carbon footprint of biomass generation can be counteracted if the carbon dioxide produced is successfully captured and stored away from the atmosphere, as is the case in the process used in the invention. Further, typical lime production methods, which generally require the release of carbon dioxide from calcium carbonate, will release carbon dioxide into the atmosphere unless positive steps are taken to sequester this. As such, to provide the greatest carbon-negativity in the process, it is desirable that the lime be sourced from suppliers who have considered the problems associated with carbon dioxide release and taken steps to address these.

Thus, one way to provide a carbon-negative process with biomass as the carbonaceous fuel, is to link the following steps, if possible (only the last of which is described in detail in this application):

a) the growing of biomass (resulting in carbon dioxide being removed from the air during photosynthesis);

b) the production of lime without emission of carbon dioxide (for instance, as described in WO 2015/015161 incorporated herein by reference); and

c) the reaction of a carbonaceous fuel with oxygen or vitiated air in the presence of lime.

The net removal of carbon dioxide from the atmosphere is beneficial from a climate perspective, and also financially beneficial if incentivised by such measures as California's Low-Carbon Fuel Standard, which rewards activities that result in the net removal of carbon dioxide from the atmosphere.

The gaseous fuel is often selected from syngas (here, a combination of carbon monoxide and hydrogen, as any carbon dioxide will have recarbonated the lime) or hydrogen.

These fuels are clean and act as excellent feedstocks for the production of longer-chain hydrocarbons. Often the gaseous fuel will be a low or zero carbon fuel, such as hydrogen, to minimise carbon dioxide production during combustion.

In the process for producing gaseous fuel, the vitiated air may comprise in the range 0-15 mol % oxygen, often in the range 1-5 mol %. At these levels the gasification reaction to produce gaseous fuel is promoted over heat generation. The lower the level of oxygen present in the vitiated air, the less combustion will occur and the more gaseous fuel will be produced. It may be that the oxygen is removed at, or close to, the point of reaction with the carbonaceous fuel, such that vitiation may often be implemented just prior to reaction, although vitiation may be implemented at any point prior to use, such that the air may be supplied pre-vitiated if appropriate.

The process will produce waste solids in addition to heat and gaseous fuel. These will include the calcium carbonate from reaction of lime with carbon dioxide, and non-combustible carbonaceous solids, which are generally in the form of ash. As such, the solids produced can comprise a mixture of the ash that would conventionally be generated by the combustion of the carbonaceous fuel and the calcium carbonate. This ash is benign, and can be disposed of in land fill, open land, or on agricultural land as a way of improving soil quality and increasing pH. The calcium carbonate may also be disposed of in these ways, or if generated separately to the ash (or separated therefrom after removal from the reactor), sold as a commodity product. Because the captured carbon dioxide (in the form of calcium carbonate) is in solid form, it does not need to be pressurised and transported by pipeline and subsequently injected into a suitable geological formation for long term sequestration. Thus the costs involved in compressing the carbon dioxide, building pipelines, pumping the carbon dioxide along those pipelines, injecting the carbon dioxide into geological formations, and monitoring the geological storage site are obviated by using the process of the invention. This is a particular advantage where the distance over which the compressed carbon dioxide would need to be transported is large.

The process may be carried out in multiple reactors. For instance, the following steps often found in the process for the generation of gaseous fuels may be carried out in one, two, or three different reactors.

a) gasification of the carbonaceous fuel to produce carbon monoxide and hydrogen;

b) reaction of carbon monoxide with water to produce carbon dioxide and hydrogen; and

c) recarbonation of lime by carbon dioxide to produce calcium carbonate.

However, it will often be the case that a single reactor is used for the gasification of the carbonaceous fuel with vitiated air in the presence of lime and water. This does not preclude the presence of apparatus for post-processing of the reaction products, for instance the presence of heat exchangers to cool the hot gaseous fuel, or separation apparatus for the gaseous fuel (for instance where the fuel is syngas and it is desirable to separate the carbon monoxide and hydrogen).

Often the reactor will be a bed reactor, which may be fixed or continuous. For process efficiency, often the reactor will be a fluidised bed reactor as this maximises (fluidised) product yield (in this case, gasification of the carbonaceous material to produce the gaseous fuel).

In a second aspect of the invention there is provided a system for a process according to the first aspect of the invention, the system comprising a reactor for the gasification of the carbonaceous fuel with vitiated air in the presence of lime and water, and a heat exchanger to extract heat from the gaseous fuel. In addition, the system may further comprise a separator for the gaseous fuel, for instance to separate carbon monoxide and hydrogen in syngas production; and a turbine for conversion of heat to electricity, among other components.

In a third aspect of the invention there is provided a use of a process according to the first aspect of the invention, or a system according to the second aspect of the invention in the generation of gaseous fuels. There is also provided a use of the process for the generation of gaseous fuels in energy distribution, optionally wherein the energy is distributed by transport of the gaseous fuel to the point of use. Alternatively, the energy may be distributed by the combustion of the gaseous fuel to provide heat energy which is converted into electrical energy.

As such, there is further provided the use of a process according to the first aspect of the invention or a system according to the second aspect of the invention in grid energy firming, optionally where the use comprises the storage and release of gaseous fuel to a grid energy system. This release may be direct release to the grid energy system, or combustion of the gaseous fuel to provide heat which is converted into electrical energy for release to the grid energy system. It will typically be the case that electrical energy is supplied to the grid when demand exceeds supply, and a gaseous fuel is produced and stored when supply exceeds demand.

Unless otherwise stated, each of the integers described may be used in combination with any other integer, as would be understood by the person skilled in the art. Further, although all aspects of the invention preferably “comprise” the features described in relation to that aspect, it is specifically envisaged that they may “consist” or “consist essentially” of those features outlined in the claims. In addition, all terms, unless specifically defined herein, are intended to be given their commonly understood meaning in the art.

Further, in the discussion of the invention, unless stated to the contrary, the disclosure of alternative values for the upper or lower limit of the permitted range of a parameter, is to be construed as an implied statement that each intermediate value of said parameter, lying between the smaller and greater of the alternatives, is itself also disclosed as a possible value for the parameter.

In addition, unless otherwise stated, all numerical values appearing in this application are to be understood as being modified by the term “about”.

In order that the invention may be more readily understood, it will be described further with reference to the figures hereinafter.

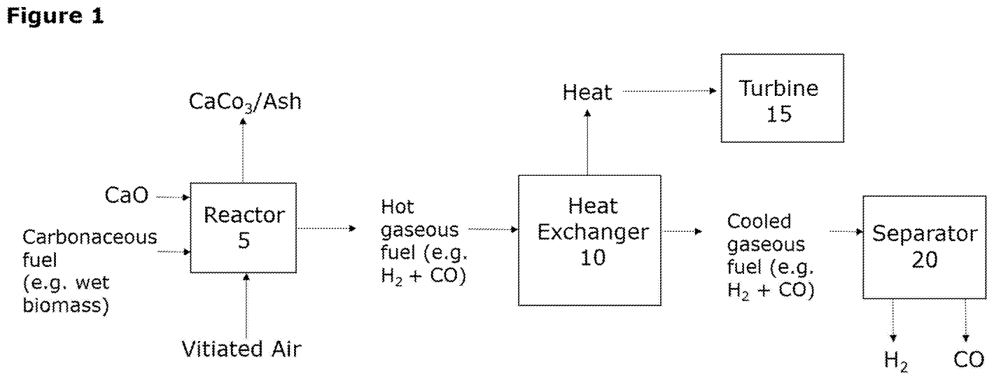

FIG. 1 is a schematic representation of a process and system of the invention comprising a single reactor together with separation of the gaseous fuels;

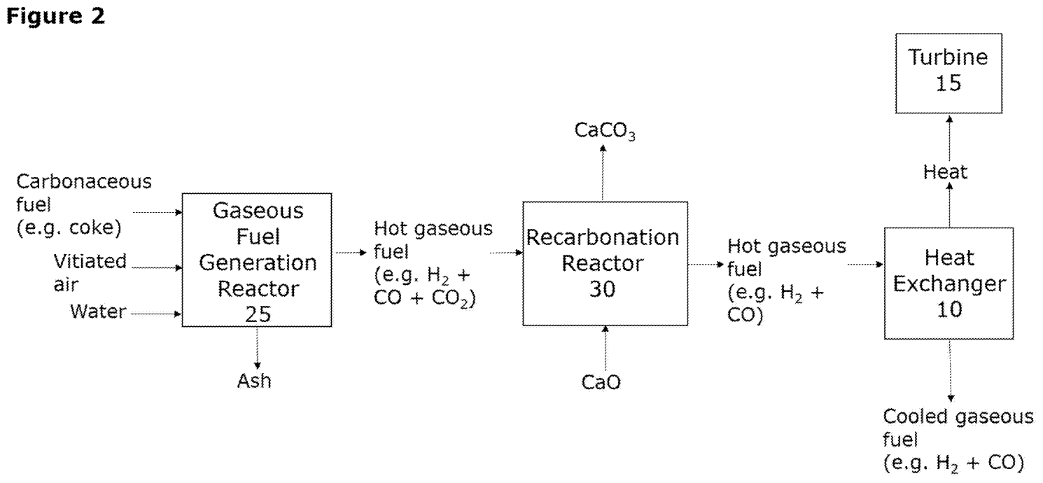

FIG. 2 is a schematic representation of a process and system of the invention comprising multiple reactors; and

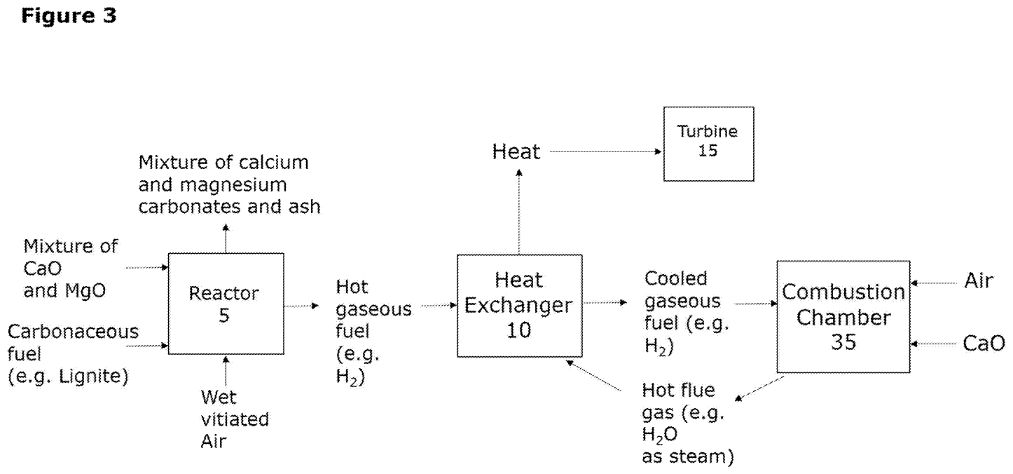

FIG. 3 is a schematic representation of a process and system of the invention comprising a single reactor, together with subsequent combustion of the gaseous fuel to generate heat.

FIG. 1 shows one implementation of the process and system of the invention. The system comprises fluidised bed reactor 5, comprising the carbonaceous fuel (for instance wet biomass) and lime. To this is added vitiated air. The solid reaction products, primarily ash and calcium carbonate are removed from the reactor and distributed on land to improve soil quality. The hot gaseous fuel, such as syngas (here carbon monoxide and hydrogen as carbon dioxide has been removed) produced passes from the reactor to a heat exchanger 10 where it is cooled. In this example, the cooled syngas is then separated in gas separator 20, to provide pure carbon monoxide and hydrogen. The heat in this process is converted to electricity in turbine 15.

FIG. 2 shows an alternative implementation of the process and system of the invention. The system of FIG. 2 comprises a fixed bed gaseous fuel generation reactor 25, however, in this implementation, the gaseous fuel generation reactor 25 does not facilitate recarbonation. Recarbonation occurs in fluidised bed recarbonation reactor 30.

As such, the hot gaseous fuel released from reactor 25 in this example includes carbon dioxide. By way of specific illustration, the carbonaceous fuel, for instance coke, is reacted with vitiated air and water in reactor 25. The gaseous fuel released from reactor 25 comprises, for instance, syngas—hydrogen, carbon monoxide—and carbon dioxide. The fuel is transferred to recarbonation reactor 30, where it is passed over lime which absorbs the carbon dioxide. After recarbonation in reactor 30, all gases are passed to heat exchanger 10, and cooled, the heat being used to generate electricity via turbine 15 and the cooled gaseous fuel is stored. In this example, the separate production of ash from reactor 25, and calcium carbonate from reactor 30 provides for the easy use of calcium carbonate as a commodity product if desired, whilst the ash may be spread on the land as before.

FIG. 3 shows a further implementation of the process and system of the invention. The system of FIG. 3 is similar to the system of FIG. 1 and comprises, a fluidised bed reactor 5, together with a heat exchanger 10, passing heat into turbine 15, and a combustion chamber 35. In this implementation, reactor 5 comprises carbonaceous fuel (in this case lignite), vitiated air, water (often provided as moist vitiated air) and a combination of lime and magnesium oxide. The solid reaction products, namely ash and calcium/magnesium carbonate are removed from reactor 5 and distributed on land. The hot gaseous fuel (in this example hydrogen) is passed to heat exchanger 10, where it is cooled. In this example, the cold fuel is then burnt in combustion chamber 35 to generate hot flue gas which can be cooled using heat exchanger 10 to generate more electricity.

In each of the above processes a conventional reforming step may also be introduced to remove hydrocarbon by-products, this step is not illustrated here.

It would be appreciated that the process and system of the invention are capable of being implemented in a variety of ways, only a few of which have been illustrated and described above.

1. A process for the generation gaseous fuels, the process comprising gasifying a carbonaceous fuel with vitiated air in the presence of a metal oxide and water to provide a metal carbonate, a gaseous fuel and heat, wherein the overall process is represented by the following reaction:
CₐH_{b}O_{c}+aMO+N₂+H₂O→N₂+CₓH_{y}+(a-x)MCO₃
wherein a, b and c are the molar component of the carbonaceous fuel, x may very from 0 to 8 and y may very from 2 to 14, MO represent metal oxide and MCO₃ represent metal carbonate.

2. A process according to claim 1, comprising:
a) gasification of the carbonaceous fuel to produce carbon monoxide and hydrogen;
b) reaction of carbon monoxide with water to produce carbon dioxide and hydrogen; and
c) recarbonation of the metal oxide by carbon dioxide to produce a metal carbonate.

3. A process according to claim 1, wherein the metal oxide is selected from calcium oxide and/or magnesium oxide, and the metal carbonate is calcium carbonate and/or magnesium carbonate.

4. A process according to claim 1, wherein the carbonaceous fuel
comprises a solid fuel.

5. A process according to claim 1, wherein the carbonaceous fuel is
selected from coal, coke, lignite, biomass, one or more hydrocarbons, or a combination thereof.

6. A process according to claim 1, wherein the gaseous fuel is selected from syngas or hydrogen.

7. A process according to claim 1, wherein the gaseous fuel is a low or zero carbon fuel.

8. A process according to claim 1, wherein the vitiated air comprises in the range 1-15 mol % oxygen.

9. A process according to claim 1, wherein the process occurs in a single reactor.

10. A process according to claim 9, wherein the reactor is a bed reactor.

11. (canceled)

12. A process according to claim 1, wherein the gaseous fuel is combusted to provide heat energy.

13. A gaseous fuel generation system for a process of claim 1,
the system comprising a reactor for the gasification of the carbonaceous fuel with vitiated air in the presence of lime and water, and a heat exchanger to extract heat from the gaseous fuel.

14. A system according to claim 13, further comprising a separator for the gaseous fuel.

15. A use of a process or system according to claim 1, in the generation of gaseous fuels.

16. A use according to claim 15, in energy distribution.

17. A use according to claim 16, wherein the energy is distributed by transport of the gaseous fuel to the point of use.

18. A use according to claim 16, wherein the energy is distributed by the combustion of the gaseous fuel to provide heat energy which is converted into electrical energy.

19. A use according to claim 15, in grid energy firming.
